(19) United States
(12) Patent Application Publication
(10) Pub. No.: US 2006/0193607 A1
(43) Pub. Date: Aug. 31, 2006

(54) Method, system and software for fast archiving from hdd to optical disk drive

(76) Inventor: Leonardus Matheus Marie Veugen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,322

(22) PCT Filed: Mar. 22, 2004
(86) PCT No.: PCT/IB04/50305

§ 371 Date: Sep. 22, 2005

(30) Foreign Application Priority Data
Mar. 27, 2003 (EP) 03100797.4

(51) Int. Cl. H04N 5/781

(52) U.S. Cl. 386/125

(57) ABSTRACT

A HDD records content that is archived on an optical disk. To facilitate the archiving, the recording on the HDD takes into account the format wherein the content is going to be stored on the optical disk. At the HDD recording stage, proper multiplexing of the audio and video segments of the content takes place together with the insertion of empty NavPack segments that at the HDD stage are being used as a Recovery segment to transport metadata. The metadata is removed prior to archiving. This configuration supports fast archiving and maintains the quality of the content.

### FIELD OF THE INVENTION

The invention relates to a system, a method and software for writing content from an HDD to an optical disk (OD), e.g., a DVD.

### BACKGROUND ART

Content information (e.g., audio, video) recorded on an optical disk (e.g., a DVD) in MPEG format is hierarchically organized into titles, program chains (PGCs), programs and video object units (VOBU). This hierarchical organization of the content information supports user-navigation throughout the recorded content information, such as jumping from one scene to another, searching for a specific scene, trick-play modes such as fast-forward and fast-reverse, multi-angle viewing, parental control, etc. In contrast, content information recorded on a HDD is accompanied by navigational data that is accommodated in a separate file, also stored at the HDD. At playback time, this file is loaded into the system's RAM.

According to the DVD standards, each title contains one or more PGCs. Each PGC contains one or more programs, which are ordered collections of pointers to cells. Each cell contains one or more VOBUs. Examples of titles of a DVD are a main feature movie, interviews with the actors starring in that movie, a documentary providing background of the movie's theme, etc. A PGC is then typically an entity such as a scene of the movie, an interview with a particular actor, a reel of historic recordings as part of the background information, etc. A VOBU represents 0.4 seconds to 1 second of playback time. Each VOBU starts with a Navigation Pack (NavPack) and is followed by several groups-of pictures (GOPs), which contain video, audio, and data packets in a time-division-multiplexed fashion. A VOBU is an entity that can be interpreted and processed by the MPEG decoder.

Several consumer electronics (CE) manufacturers are marketing video recorders that combine a hard disk drive (HDD) with an optical disk drive (ODD), e.g., for a re-writeable DVD. The latter type is typically referred to as an HDD-DVD combination box, or “combi” for short. Such a combi then represents an HDD-based video recorder, also known as personal video recorder (PVR), enhanced with archival capabilities provided by the OD. Further, a typical up-to-date PC has a HDD, a CD drive and a DVD drive, preferably with CD- and DVD-burning equipment Again, a DVD+RW can be used to archive audio/video content recorded at the HDD.

### SUMMARY OF THE INVENTION

The inventor has realized that by paying a very small overhead during the HDD recording, the OD archiving from HDD to OD can be expedited and facilitated. Content on an OD is to comply with the formatting standards for optical disks. In order to comply with the format requirements of the OD a NavPack is needed at each VOBU. Conventional archiving from HDD to OD requires the HDD data to be decoded, then encoded again and multiplexed in order to have it properly formatted for writing to the OD. These additional steps take time and require processing power, and, in addition, affect the eventual quality of the content as archived on the OD.

The invention provides a method and system for writing or archiving content information recorded on an HDD to an optical disk in a time-efficient and resource-efficient manner, that is faster than the conventional transcoding and that preserves quality of the content as recorded on the HDD.

More specifically, the invention relates to a method of enabling to archive content on an optical disk. The method comprises enabling to record segments of the content on a HDD in a multiplexed manner according to a formatting standard of the optical disk and reserving an additional segment for a NavPack. Preferably, the method comprises extracting metadata from the content prior to recording on the HDD and using the additional segment to store the metadata. The metadata is then removed from the additional segment prior to archiving to the optical disk. In short, the data as recorded on the HDD in the invention already partly complies with the format of the data to be archived on the OD later on. The content data is copied without re-encoding and without de-multiplexing and re-multiplexing as it already complies with the audio/video buffer model for the optical disk data. In order to comply with the format requirements of the optical disk a NavPack is needed at each VOBU. An HDD, on the other hand, uses a different navigation strategy. According to the invention, an empty segment is recorded at the HDD at the beginning of each VOBU. The segment is then temporarily used to store metadata needed further down the road, prior to the actual archiving on the optical disk. During writing to the optical disk, the empty segments are to be filled in as correct NavPacks. During the recording at the HDD, the segment cannot get filled in if the cell-identifiers at the optical disk are unknown.

### BRIEF DESCRIPTION OF THE DRAWING

The invention is explained in further detail, by way of example and with reference to the accompanying drawing wherein:

FIG. 1 is a block diagram of a system in the invention; and

FIG. 2 is a diagram illustrating a VOBU.

Throughout the figures, same reference numerals indicate similar or corresponding features.

### DETAILED EMBODIMENTS

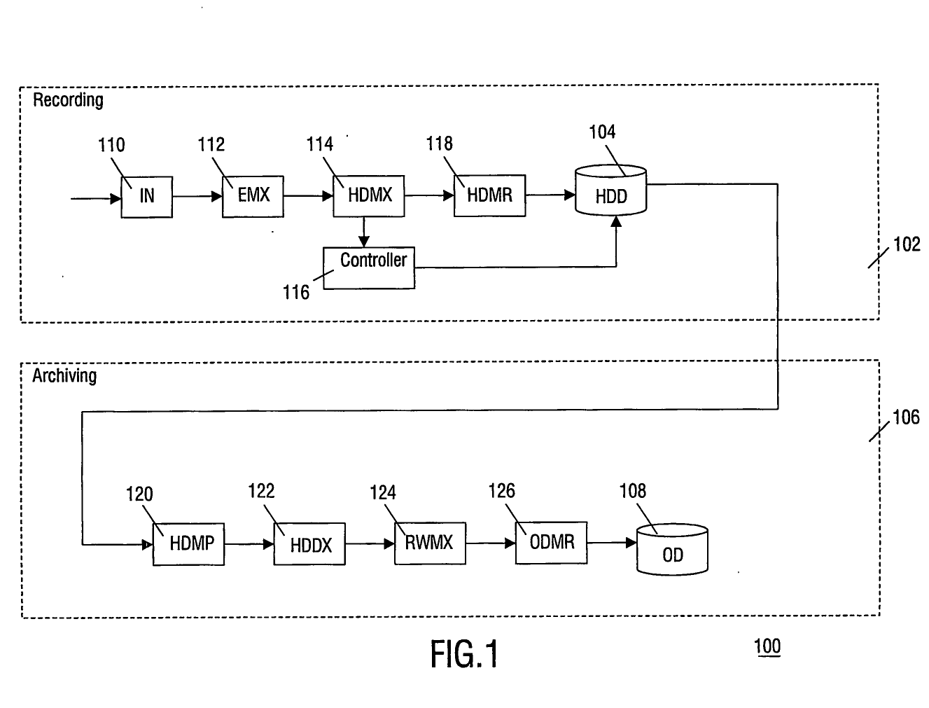

FIG. 1 is a block diagram of a system 100 in the invention. System 100 has a recording portion 102 that enables to record audio/video content on a HDD 104. System 100 also has an archiving portion 106 to archive the content recorded on HDD 104 on an OD 108. The invention relates to a method of enabling fast archiving. At the recording stage, a very small overhead is needed in order to enable archiving without decoding and subsequent encoding, and without multiplexing in the archiving stage. As a bonus, the quality of the recorded content is maintained.

Recording portion 102 comprises an input stage (IN) 110, an encoder-multiplexer (CMX) 112, a hard-disk multiplexer (HDMX) 114, a hard-disk manager recording (HDMR) 116 and a controller 118.

Input stage 110 receives the content as an input signal, for example, as an analog or digital TV broadcast signal, an analog camcorder signal, a digital video signal from a DV camcorder, etc. Stage 110 filters the analog signal and digitizes it, or converts the received digital signal to a uniform digital signal for further processing. Stage 110 further determines the attributes of the input signal, e.g., its format such as PAL/NTSC, WSS (wide screen signaling information for PAL or NTSC), copy-protection characteristics, etc., and creates metadata carrying this attribute information.

EMX 112 receives the digital content data and the metadata from IN stage 110. EMX 112 performs encoding and multiplexing operations. EMX 112 encodes the content data from an uncompressed format to a compressed format, e.g., to MPEG. In MPEG encoding, data is recorded in 2 KB units, referred to as “segments”. The following types of segments exist: Video segments, Audio segments, NavPack segments, Sub-picture segments and Recovery segments. Video segments carry video data. Audio segments carry audio data. Navpack segments carry navigation data essential to DVD applications, but not needed for conventional HDD recordings. Sub-picture segments are optional and can be used to represent, e.g., subtitles and user-specific information such as time and date of the recording, for being rendered as an overlay during playback. Recovery segments can be used to store the metadata.

As regards Recovery segments, there are several options for adding them to a data stream. One manner is that EMX 112 adds Recovery segments regardless of the bitrate. As a consequence, these Recovery segments have to be removed from the data stream prior to archiving on OD 108. The reason for this is that standards relating to OD, e.g., DVD standards, put high demands on the bitrate for reading and decoding. Another manner is that EMX 112 adds Recovery segments dependent on the bitrate. These Recovery segments are then archived on OD 108 together with the other data and this requires extra storage capacity on OD 108. Yet another manner is to have the Recovery segments added by HDMX 114 without taking bitrate into account. This has the same effect as if EMX 112 would do this without taking bitrate into account.

As to NavPacks, the following scenarios exist. A first one is that EMX 112 does not put NavPacks into the stream to save storage capacity on HDD 104. A second scenario is that EMX 112 does put Navpacks into the stream and that HDMX 114 removes them again to save HDD storage capacity. A third scenario, preferred in the invention, is that EMX 112 puts NavPacks into the stream and that HDMX does not remove them and optionally uses them as Recovery segments.

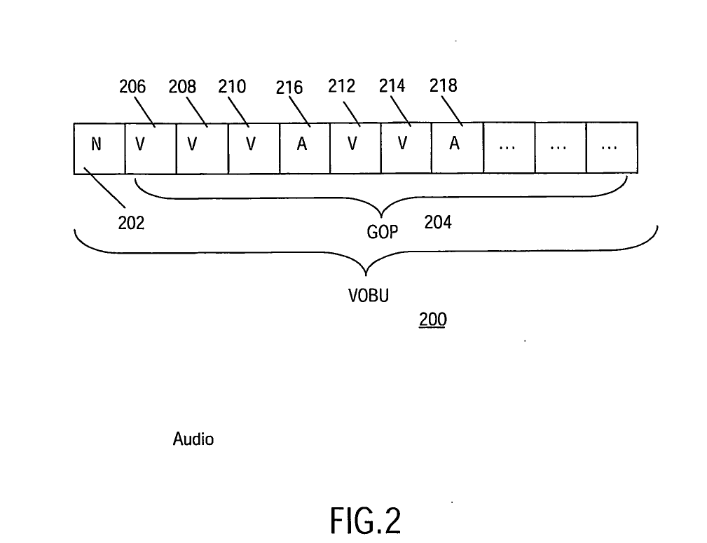

According to the invention, EMX 112 multiplexes Video segments, Audio segments, and (empty) NavPack segments so as to arrange them in the order as prescribed by the DVD and DVD+RW standards. In other words, EMX 112 prepares data packets in the VOBU format, see FIG. 2. As discussed above, each VOBU starts with a NavPack and is followed by one or more GOPs, which contain video, audio, and data packets in a time-division-multiplexed fashion. EMX 112 in the invention takes into account the bit size and location in the stream to be occupied by the 2 KB NavPacks. The DVD standards put high demands on the bitrate for reading and decoding. By means of reserving at this stage the space and location for NavPacks, fast archiving is going to be achieved.

Optionally, EMX 112 generates additional metadata to be combined with the metadata from IN stage 110.

HDMX 114 receives a stream of MPEG data segments and metadata from EMX 112. HDMX 114 adds Recovery segments, or uses as Recovery segments the empty segments inserted by EMX 112, and writes metadata into the Recovery segments. The frequency of the Recovery segments depends on the size of the metadata. In addition, one could have Recovery segments dispersed in a variety of manners. For example, Recovery segments could occur periodically, e.g., after an integer number of N other segments. Alternatively, Recovery segments are coupled to VOBUs, which has advantages later on at the splitting of a title. For example, each VOBU can be assigned an individual Recovery segment or a Recovery segment is assigned to a group of K VOBUs, K being an integer equal to three, for instance. This latter variant results in an efficient usage of the storage capacity of HDD 104.

HDMX 114 further forwards to controller 116 all navigation data needed for playback of the content from HDD 104.

HDMR 118 receives from HDMX 114 MPEG data segments with filled-in Recovery segments, optionally together with the metadata. HDMR 118 controls the recording of the MPEG data on HDD 104, and leaves out the metadata.

Archiving portion 106 comprises a hard disk manager playback unit (HDMP) 120, a hard disk demultiplexer (HDDX) 122, a DVD+RW multiplexer (RWM) 124, and an OD manager recording unit (ODMR) 126.

HDMP 120 reads the MPEG data recorded on HDD 104 that are to be archived.

HDDX 122 receives the MPEG data from HDMP 120 and reconstructs the metadata on the basis of the metadata that HDMX 114 has put into the Recovery segments. HDDX 122 removes the Recovery segments from the data stream to be able to comply with the bitrate requirements of the DVD+RW, and adds a NavPack segment at the beginning of each VOBU, if this was not done already, see the NavPack scenario options above. HDDX 122 then forwards the MPEG data segments and the metadata to RWMX 124.

RWMX 124 fills in the NavPack segments according to the DVD+RW standard. RWMX 124 buffers a number of VOBUs equivalent to approx. 3 seconds of play-out time prescribed by DVD+RW standard, in order to calculate forward reference pointers that relate to disc sector numbers regarding future VOBUs. Backward reference pointers can all be filled in. RWMX 124 also puts the attribute information (see above) into the NavPacks that is retrieved from the metadata. RWMX 124 thus provides a DVD+RW compatible MPEG stream to ODMR 126.

ODMR 126 controls the recording of the MPEG stream on OD 108 without the separate metadata Of course, the table of contents of OD 108 needs to be updated as a result of the additional recording, either per archived item or per batch.

Functionalities 112-126 can be implemented purely in hardware, or in software or a combination of software and hardware. A software implementation can be realized by installing the software on a suitable platform e.g., a PC, or a CE apparatus such as a combi-box.

In an embodiment of the invention, recording portion 102 and archiving portion 104 are accommodated in a PC or in a CE apparatus, e.g., a combi-box as introduced above. In another embodiment, portions 102 and 104 are physically separated entities distributed on, e.g., a home network or a commercial data network. As to the latter, a service provider provides the option to have the customer locally record the content either in a conventional manner that needs transcoding and therefore looses quality, or in the manner of the invention as preparation to fast archiving. As noted, the invention maintains quality and expedites archiving.

FIG. 2 illustrates the configuration of a VOBU 200 as a concatenation of a NavPack segment 202 followed by one or more GOPs 204, one of which is illustrated in the drawing. GOP 204 comprises Video segments 206, 208, 210, 212, 214, . . . , and Audio segments 216, 218, . . . interspersed there between.

The following patent documents may provide a relevant context to interpret the above invention and its fields of use, and are incorporated herein by reference:

U.S. Pat. No. 6,070,226 (attorney docket PHA 23,183) issued to Martin Freeman and Uzi Bar-Gadda for MAGNETIC DISK DRIVE PHYSICALLY INTEGRATED WITH OPTICAL DISK DRIVE 1N STORAGE HIERARCHY discloses a data processing system with a hierarchical memory. The hierarchical memory comprises a memory module that has a plurality of memory units. Each respective one of the memory units represents a respective level in a hierarchy of the hierarchical memory. Each specific one of the memory units is physically integrated with a particular memory unit of a next higher level in the hierarchy of the hierarchical memory. Among the memory units there are an optical disk drive and a magnetic disk drive. The magnetic disk drive is physically integrated with the optical disk drive and serves as a read cache for the optical disk drive. This configuration reduces latency and enables to build compact data processing systems, such as for CE applications.

U.S. Ser. No. 09/521,051 (attorney docket US 000052) filed Mar. 8, 2000, for Geert Bruynsteen for BUSINESS MODEL FOR LEASING STORAGE SPACE ON A DIGITAL RECORDER, published under PCT as International Application WO0167743. This patent document relates to adjusting, via a data network, the available amount of storage space of a fixed HDD on a CE device. The consumer can upgrade the device via a third party service that remotely control's the HDD's settings.

U.S. Ser. No. 09/519,546 (attorney docket US 000014) filed Mar. 6, 2000, for Erik Ekkel et al., for PERSONALIZING CE EQUIPMENT CONFIGURATION AT SERVER VIA WEB-ENABLED DEVICE, published under PCT as International Application WO0154406 with modified title METHOD OF CONFIGURING A CONSUMER ELECTRONICS APPARATUS. This document relates to the configuring of CE equipment by the consumer. The setting up of the configuration is facilitated by means of delegating the configuring to an application server on the Internet The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/189,535 (attorney docket PRA 23,527) filed Nov. 10, 1998, for Eugene Shteyn for UPGRADING OF SYNERGETIC ASPECTS OF HOME NETWORKS, published under PCT as International Application WO0028436. This document relates to a server that has access to an inventory of devices and capabilities on a user's home network. The inventory is, for example, a look-up service as provided by HAVi or Jini architecture. The server has also access to a database with information of features for a network. The server determines if the synergy of the apparatus present on the user's network can be enhanced based on the listing of the inventory and on the user's profile. If there are features that are relevant to the synergy, based on these criteria, the user gets notified.

U.S. Pat. No. 6,377,518 (attorney docket PHN 17,172) issued Apr. 23, 2002, to Johan Auwens and Robert Brondijk for METHOD AND DEVICE FOR RECORDING REAL-TIME INFORMATION. This document relates to arranging video information according to a recording format, e.g. DVD-video, for being playable in standardized players. The video information is subdivided into cells and playback parameters for reproducing sequences of the cells are included in control information. The format prescribes that within the recording area the control information precedes the video information for playback functions of the recorded video. However for home recording it is preferable that a recording is made in one pass, i.e. the video is to be recorded directly at its final location. Therefore the recorder has a control unit for performing the following steps: first creating a free area by selecting a starting point within the recording area different from the beginning of the recording area, thereafter recording the real-time information from the starting point, and recording the control information in said free area.

US patent application published as US20020131767 (attorney docket PHN 17,172) published Sep. 19, 2002, and filed for Johan Auwens and Robert Brondijk for METHOD AND DEVICE FOR RECORDING REAL-TIME INFORMATION. This document relates to a method and device for recording video on a record carrier, e.g. an optical disc. The information is arranged according to a recording format, e.g. DVD-video, for being playable in standardized players. The video information is subdivided into cells and playback parameters for reproducing sequences of the cells are included in control information. The format prescribes that within the recording area the control information precedes the video information for playback functions of the recorded video. However for home recording it is preferable that a recording is made in one pass, i.e. the video is to be recorded directly at its final location. Therefore the recorder has a control unit for performing the following steps: first creating a free area by selecting a starting point within the recording area different from the beginning of the recording area, thereafter recording the real-time information from the starting point, and recording the control information in said free area.

1. A method of enabling to archive content on an optical disk, the method comprising enabling to record segments of the content on a HDD in a multiplexed manner according to a formatting standard of the optical disk.

2. The method of claim 1, comprising reserving an additional segment for a NavPack when recording on the HDD.

3. The method of claim 2, comprising extracting metadata from the content prior to recording on the HDD and using the additional segment to store the metadata.

4. The method of claim 3, comprising removing the metadata from the additional segment prior to archiving to the optical disk.

5. A data processing system comprising an HDD and an ODD, wherein the system enables to archive content on an optical disk by means of recording segments of the content on a HDD in a multiplexed manner according to a formatting standard of the optical disk.

6. The system of claim 5, operative to reserve an additional segment for a NavPack while recording on the HDD.

7. The system of claim 6, operative to extract metadata from the content prior to recording on the HDD and using the additional segment to store the metadata.

8. The system of claim 7, operative to remove the metadata from the additional segment prior to the archiving of the content on the optical disk.

9. The system of claim 5, being a PC.

10. The system of claim 5, being a CE apparatus.

11. Software for being installed on a data processing system comprising an HDD and an ODD to enable archiving content on an optical disk, wherein the software is operative to enable to record segments of content on the HDD in a multiplexed manner according to a formatting standard of the optical disk.

12. The software of claim 11 operative to reserve an additional segment on the HDD for a NavPack

13. The software of claim 12, operative to extract metadata from the content prior to the recording on the HDD and to store the metadata in the additional segment.

14. The software of claim 13, operative to remove the metadata from the additional segment prior to archiving to the optical disk.
